(19) United States
(12) Patent Application Publication
(10) Pub. No.: US 2010/0101492 A1
(43) Pub. Date: Apr. 29, 2010

(54) Reusable High-Temperature Resistant Masking System

(76) Inventors: Kissak Sarajian, Franksville, WI (US); Christopher Malone, Franksville, WI (US)

Correspondence Address: ABSOLUTE TECHNOLOGY LAW GROUP LLC, 135 W. WELLS ST., SUITE 518, MILWAUKEE, WI, 53203, US

(21) Appl. No.: 12/558,272

(22) Filed: Sep. 11, 2009

Related U.S. Application Data
(60) Provisional application No. 61/109,243, filed on Oct. 29, 2008.

(51) Int. Cl. B05C 21/00; B23P 11/00

(52) U.S. Cl. 118/504; 29/428

(57) ABSTRACT

A masking device that is adapted to be reusable in high temperature applications and for a variety of masking applications, is cost-effective to manufacture, and which includes a magnetic component insulated on three or all four surfaces. The invention includes a system of interchangeable components in varying shapes and sizes, which may be selectively attached, assembled and combined providing versatility for a range of masking operations.

### CROSS-REFERENCE TO RELATED APPLICATIONS

This application claims priority to U.S. Provisional Application No. 61/109,243 filed on Oct. 29, 2008.

### FIELD OF INVENTION

This invention relates generally to the field of masking devices, and more particularly to reusable high-temperature resistant masking devices incorporating magnets.

### BRIEF DESCRIPTION OF DRAWINGS

FIG. 1a shows a cross-sectional view of the components of an exemplary embodiment of a masking device in an unassembled position.

FIG. 1b shows a side perspective view of the components of an exemplary embodiment of a masking device in an assembled position so that the magnet is insulated.

FIG. 2a shows a side perspective view of an exemplary embodiment of a housing member with tapered sides and a centering protrusion.

FIG. 2b shows a side perspective view of an exemplary embodiment of a housing member with tapered sides and an elongated centering protrusion.

FIG. 2c shows a side perspective view of an exemplary embodiment of a housing member with tapered sides and a smooth surface with no centering protrusion.

FIG. 3a shows a perspective view of a second exemplary embodiment of a housing member with straight sides.

FIG. 3b shows a top perspective view of a second exemplary embodiment of a housing member with straight sides.

FIG. 3c shows a cross-sectional view of a second exemplary embodiment of a housing member with straight sides.

FIG. 4 shows a side perspective view of a third exemplary embodiment of a masking device in which the housing members are of different diameters.

FIG. 5 shows a side perspective view a fourth exemplary embodiment of a masking device in which the housing members are triangular shaped.

FIG. 6a shows a side perspective view of a fifth exemplary embodiment of an optional neck extension component for a masking device.

FIG. 6b shows a cross-sectional view of an optional neck extension component in conjunction with first and second housing members.

FIG. 7 shows a side perspective view of an exemplary embodiment of a masking device and system in the form of a kit comprised of interchangeable first and second housing members that can be adapted for a wide variety of masking functions.

FIG. 8a shows a top perspective view of a sixth exemplary embodiment of a masking device manufactured as a unitary component.

FIG. 8b shows a side perspective view of an exemplary embodiment of a masking device manufactured as a unitary component.

FIG. 8c shows a cross-sectional view of an exemplary embodiment of a masking device manufactured as a unitary component.

FIG. 9a shows a cross-sectional view of a second exemplary embodiment of a masking device manufactured as a unitary component.

FIG. 9b shows a side perspective view of a second exemplary embodiment of a masking device manufactured as a unitary component.

FIG. 10a shows a cross-sectional view of an optional lid for a masking device manufactured as a unitary component.

FIG. 10b shows a side perspective view of an optional lid for a masking device manufactured as a unitary component.

### GLOSSARY

As used herein, the term “centering protrusion” or “grasping protrusion” means any structural contour or protuberance on a masking device which aids a user in centering and/or positioning the device over an area to be masked.

As used herein, the term “coating” means any type of substance which is applied to a surface to form a coating. Examples of coating include but are not limited to powder coating, wet spray, e-coat, dipping, plating and treating.

As used herein, the term “deflecting lip” or “overhang” means any design feature that minimizes paint burr and deflects paint along the sealing surface, including but not limited to a contour, protrusion, protuberance, ridge, channel, groove, curve, chamfer, rounded edge, equivalents and combinations thereof.

As used herein, the term “deflecting lip depth” means the distance from the outermost diameter of the lip to the sealing surface.

As used herein, the term “deflecting lip height” means the distance between the bottom surface of the masking device and the bottom edge of the deflecting lip.

As used herein, the term “deformable” means a material that is flexible and allows its shape to be temporarily changed. For example, deformable material may include, but is not limited to, silicone, EPDM rubber, nylon, synthetic polymers, elastomers, equivalents and combinations thereof.

As used herein, the term “ferrous” or “ferrous surface” means any surface to which a magnet is attracted thus creating an adherent force.

As used herein, the term “housing” or “housing member” means a component that wholly or partially covers, surrounds, or insulates another component.

As used herein, the term “interlocking” means two or more components that are designed to fit together to ensure coordinated action.

As used herein, the term “magnetic” refers to any material that creates an adherent force on a ferrous or other metal surface.

As used herein, the term “manufacture” means the making of a component by a process that includes, but is not limited to, machining and molding.

As used herein, the term “masking” means providing a barrier on the area of an object to be powder coated or coated by other means to limit the area's exposure to the coating substance.

As used herein, the term “paint burr” or “paint burring” means paint build-up along the sealing surface.

As used herein, the term “powder coating build up” means powder or other coating substances that accumulate over time on the surface of a reusable masking device.

As used herein, the term “sealing surface” means the point where the masking device contacts the surface of the object to be coated.

As used herein, the term “Teflon” or “Teflon equivalent” shall include any product made from one of three types of fluorine-containing polymers (i.e., polytetrafluoroethylene (PTFE), perfluoroalkoxy polymer resin (PFA), and fluorinated ethylene-propylene (FEP)) having temperature resistant and non-adherent, qualities, including but not limited to materials manufactured under the Teflon™ trademark. As used herein, Teflon may include products, such as silicone, EPDM rubber, nylon or other high temperature rated substances having equivalent or similar qualities.

As used herein, the term “unitary” means a component that is comprised of a single piece or unit.

### BACKGROUND

Masking plays a vital role in the painting or coating of parts used in the automotive, aerospace, electronics, and other industries. The painting or coating of parts may involve liquid coating, plating, powder coating, or electroplating. The coating may be applied by a variety of methods including brushing, rolling, spraying, dipping, flow-coating, electrostatic coating, and submersion in deposition tanks. The liquid, powder or plating material may be applied to wood, fiberglass, or metal surfaces in order to protect and strengthen those surfaces. The coating protects the surface of a part by preventing electrical leakage, oxidation, corrosion and decay. Once the coating is applied, it is often cured at temperatures between 200 and 600° Fahrenheit to harden and cross-link the coating on the surface. After the curing process is complete, the cured coating forms a very strong protective layer on the surface that is highly resistant to scratching and chipping.

In most applications, a protective coating is applied only to certain areas of a surface and not to all areas of the surface. The areas where the coating is not to be applied must be covered or masked.

Masking technology is typically used in the manufacturing of machinery (e.g., automobiles, furniture, industrial equipment, restaurant and institutional equipment, toys, medical and consumer items). Masking is used when certain parts must be coated with various materials and substances to adapt those parts for their intended end use. The coatings impart desired characteristics to the parts, such as resistance to corrosion or friction. Many different types of materials can be applied to the parts including nylon, polycarbonates, metals, etc. Among the well-known types of coating, operations used to apply various substances to parts include coating by powder coating, anodizing and plating.

Typically, in these coating operations, the surface portions of the part are completely exposed to the coating substance. In powder coating operations, the part to be coated is generally electrostatically charged, and then exposed to a fine particulate spray or fluidized bath of oppositely charged particles and then heated. The particles are attracted to the surface to be coated and are melted, forming a coating over the surface of the part. In anodizing and plating operations, the part to be coated is charged and then dipped into a bath containing the coating material. The coating material is attracted to the surface of the part and is deposited onto the exposed surface portions of the part.

Many parts to be coated include internal surface portions which must not be coated. These types of parts are typically three-dimensional, include outer and inner surface portions and include various openings (also known as holes) in the part's outer surface through which coating materials could enter the part and undesirably come into contact with the internal surface portions of the part.

It also may be undesirable to mask the internal surface portions of these types of parts. For example, it may be undesirable to apply a coating to the internal surface portions of a valve or pipe because that coating may be incompatible with fluids or gases conveyed through the valve or pipe. Also by way of example, it may be undesirable to apply a coating to threads cut in the internal surface portion of an annular opening in a tube or other part because that coating may interfere with operation of the threads. It may also be undesirable for the liquid media used in plating or anodizing operations to come into contact with the internal surface portions of a part because the media can damage the internal surface portions of the part.

Various products have been developed to mask, or close, the openings in these parts thereby preventing coating materials from coming into contact with the internal surface portions of the parts. For example, a variety of tape devices, caps and plugs are commercially available to mask surface portions, recesses and apertures of a part to be coated.

Currently, many of these masking devices, such as those disclosed by Sarajian in U.S. Pat. No. 6,419,104 (Sarajian '104), are relatively expensive to use because they are disposable. In addition, these masking devices require careful positioning or are sized and configured for limited masking applications. For example, Sarajian '104 discloses a plug device that has a compression mechanism that compresses the plug body between an internal plug anchor and an opposed plug compression surface. The compressive force causes the plug circumference to increase forming a tight seal between the plug and walls forming the opening. The internal anchor design and absence of any axial opening through the entire plug body prevents fluids and other coating materials from passing through the internal plug body and into the interior of the part to be coated, thereby avoiding costly damage to the part. This product is reusable, but is not versatile in that each plug has a specific range of variation in its circumference; thus, multiple plugs must be used for variable masking activities.

Another common type of masking device is silicone adhesive tape. This tape is readily available in pre-cut disc sizes. There are inherent drawbacks that limit the utility of tape for masking in coating operations, including its inability to adhere to oily or contaminated surfaces, difficulty in centering the disc, and difficulty removing the disc after the coating process. Examples of such adhesive devices are disclosed in U.S. Pat. No. 6,656,558 (Sarajian '558) and in U.S. Pat. No. 5,800,894 (Navis '894). These adhesive devices are not reusable, although they are highly versatile and are available in a wide variety of shapes and sizes to meet particular masking applications.

Additionally, devices that rely on an adhesive to stick to the surfaces being coated have inherent drawbacks. The adhesives devices must be accurately positioned, generally by unskilled labors that may have varying degrees of manual dexterity. The cost of labor/time in positioning must be calculated in the cost of using these disposable devices.

There are also masking devices known in the art which incorporate a magnet as a way to secure the device to a masking surface. However, devices, such as the one disclosed in Swedish Patent No. 000421805-0003 (“Törefors”), are typically of unitary construction and are not designed to surround all surfaces of the magnet. As a result, paint or coating material may adhere to the exposed portion of the magnet, reducing the effectiveness and longevity of the magnet.

It is desirable to have a highly versatile, reusable masking device which maximizes the usable life of a magnet by protecting it from powder coating or other types of coating build-up.

It is further desirable to have a highly versatile, reusable masking device which minimizes paint burring.

It is further desirable to minimize the manufacturing costs associated with creating a reusable masking device.

### SUMMARY OF THE INVENTION

The invention disclosed herein is a masking device that is adapted to be reusable in high-temperature applications and for a variety of masking applications, is cost-effective to manufacture, and which includes a magnetic component insulated on three or all four surfaces. The invention herein may further include interchangeable component parts in varying shapes and sizes, which may be selectively attached, assembled and combined to provide versatility for a range of masking operations. Alternatively, the apparatus disclosed herein may be comprised of a unitary component for enclosing a magnet component to reduce manufacturing costs associated with production of multiple parts.

### DETAILED DESCRIPTION OF EMBODIMENTS OF THE INVENTION

For the purpose of promoting an understanding of the present invention, references are made in the text hereof to embodiments of a reusable high-temperature resistant masking device, only some of which are described herein. It should nevertheless be understood that no limitations on the scope of the invention are thereby intended. One of ordinary skill in the art will readily appreciate modifications such as the variation of size and shape of housing components. Some of these possible modifications are mentioned in the following description. Therefore, specific details disclosed herein are not to be interpreted as limiting, but rather as a basis for the claims and as a representative basis for teaching one of ordinary skill in the art to employ the present invention in virtually any appropriately detailed apparatus or manner.

It should be understood that the drawings are not necessarily to scale; instead, emphasis is being placed upon illustrating the principles of the invention. In addition, in the embodiments depicted herein, like reference numerals in the various drawings refer to identical or near identical structural elements.

Moreover, the term “substantially” or “approximately” as used herein may be applied to modify any quantitative representation that could permissibly vary without resulting in a change in the basic function to which it is related.

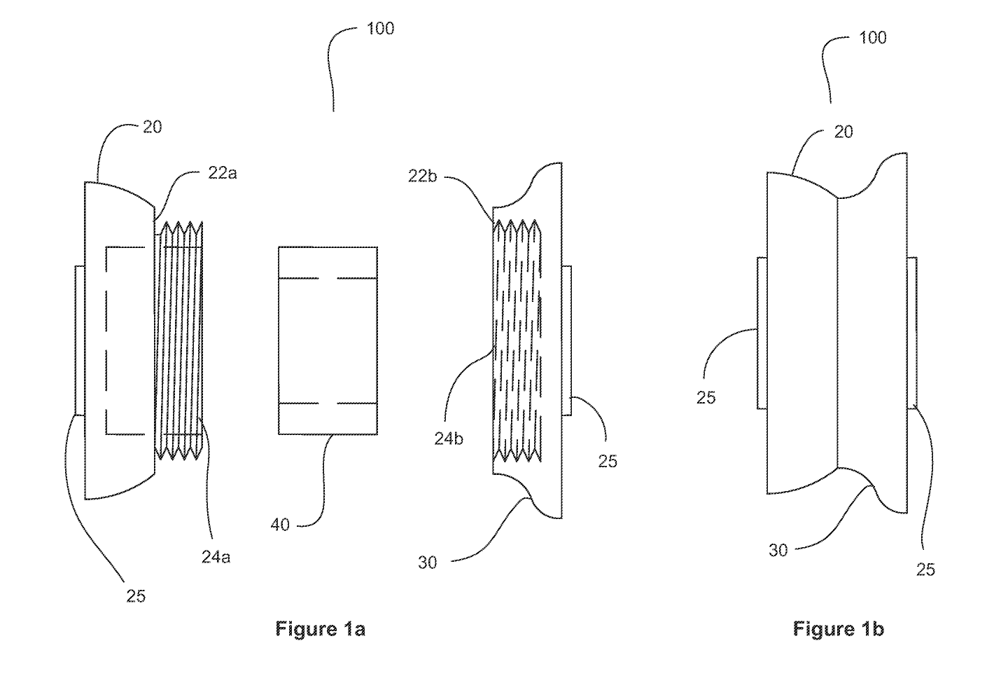

Referring now to the drawings, FIG. 1a shows a cross-sectional view of the individual components of an exemplary embodiment of a reusable high-temperature resistant masking device 100 for selectively masking surfaces during a coating operation, e.g., the application of a powder coating. Reusable high-temperature resistant masking device 100, as shown in FIG. 1a, is comprised of first housing member 20, second housing member 30, and magnet 40. In the embodiment shown, first housing member 20 has a slightly rounded side and second housing member 30 has a curved concave side. In other embodiments, first housing member 20 and/or second housing member 30 may have straight sides, curved sides, rounded sides or tapered sides with varying degrees of angling.

Alternative embodiments of reusable high-temperature resistant masking device 100 may include more or fewer housing members, housing members which are selectively attachable in various configurations, and housing members which are molded as a single component and are not selectively removable. Further, housing members may be of the shape or size of any masking device known in the art or adapted to serve a masking function known in the art. In all embodiments of reusable high-temperature resistant device 100, the device may also be disposable. In all embodiments of reusable high-temperature resistant masking device 100, the device may further have a layer of paint resistant coating or a release agent on the outer surface to deflect paint or coating and/or reduce paint burring.

In the exemplary embodiment shown in FIG. 1a, first housing member 20 and second housing member 30 are adapted to hold magnet 40 so that magnet 40 is enclosed on all four sides when first housing member 20 and second housing member 30 are joined together; thereby forming a housing which insulates magnet 40 on all or substantially all surfaces. It will be apparent to one of ordinary skill in the art that first housing member 20 and second housing member 30 may be joined together so that either first housing member 20 or second housing member 30 may function as a “top” component while the other functions as a “bottom” component. Additionally, the surfaces of first housing member 20 and second housing member 30 may be of equivalent or disparate sizes.

In the embodiment shown, first housing member 20 and second housing member 30 include structurally fitted necks 22a and 22b. Fitted necks 22a and 22b have complementary configurations and are adapted to join first housing member 20 and second housing member 30 together to form a single housing member for enclosing magnet 40. In the illustrated embodiment, fitted neck 22a has external threading 24a and fitted neck 22b has internal threading 24b which permit joining of first housing member 20 and second housing member 30. In other embodiments, fitted necks 22a and 22b may also have a snapping, fitted or tapered seal, or manufactured in any other configuration that permits selective and temporary joining of first housing member 20 and second housing member 30. Alternatively, first housing member 20 and second housing member 30 may be permanently joined or singly molded to form the single housing unit.

In the illustrated embodiment, magnet 40 has a rounded or disc configuration. It is to be understood, however, that magnet 40 may be of any shape, size, thickness, or of any proportion. For example, magnet 40 may be a solid or hollow magnet. In addition, a single magnet or any number of magnets may be used.

First housing member 20 and second housing member 30 may be formed of any high-temperature resistant insulating material suitable for use in coating and curing operations. In particular, first housing member 20 and second housing member 30 are formed of a material capable of withstanding repeated exposure to temperatures of 100 to 1200 degrees Fahrenheit.

FIG. 1b illustrates a side perspective view of the components of an exemplary embodiment of a reusable high-temperature resistant masking device 100 as shown in FIG. 1a in an assembled position in which magnet 40 is encased or housed within first housing member 20 and second housing member 30. All or substantially all surfaces of magnet 40 are surrounded and insulated by first housing member 20 and second housing member 30. By fully encasing magnet 40, first housing member 20 and second housing member 30 increase the useful life of magnet 40 by protecting all four surfaces from exposure to and the build-up of coating material or other debris as well as from high temperatures which may reduce the strength (and therefore the longevity) of magnet 40.

In the embodiment shown, first housing member 20 and second housing member 30 include optional centering protrusion 25. Centering protrusion 25 may be of any size and shape so as to permit easy grasping by a user or other anthropometric or ergonomic modifications. Centering protrusion 25 may be included or omitted on either or both of first housing member 20 and second housing member 30; may be of the same or of different size or configuration; may be rectangular, oval or circular; and may be of various thicknesses, made of various materials and/or have irregular or regular contours.

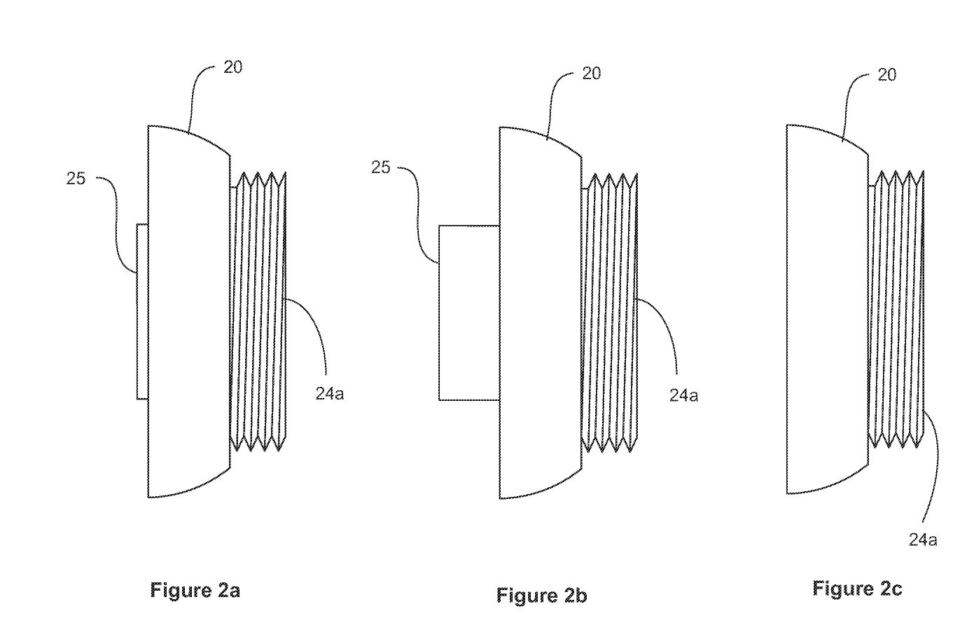

FIG. 2a shows a side perspective view of an exemplary embodiment of first housing member 20 having centering protrusion 25. Centering protrusion 25 is adapted to hold reusable high-temperature resistant masking system 100 in place centrally within a hole or aperture. In the embodiment shown, first housing member 20 has rounded sides. Also visible is external threading 24a.

FIG. 2b shows a side perspective view of an embodiment in which first housing member 20 has an elongated centering protrusion 25 that can also be used for grasping first housing member 20. In the embodiment show, first housing member 20 has rounded sides. Also visible is external threading 24a.

FIG. 2c shows a side perspective view of an embodiment in which first housing member 20 has a smooth or substantially flattened surface. In the embodiment shown, first housing member 20 has rounded sides. Also visible is external threading 24a.

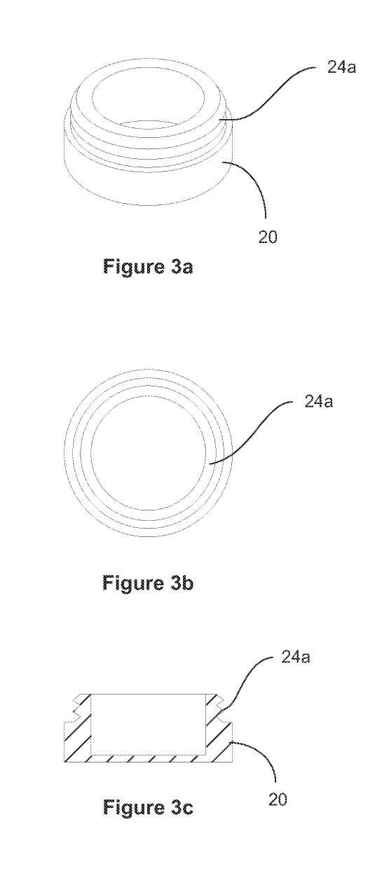

FIG. 3a shows a perspective view of a second exemplary embodiment of first housing member 20. In the embodiment shown, first housing member 20 has straight sides and external threading 24a.

FIG. 3b shows a top perspective view of an exemplary embodiment of first housing member 20 with external threading 24a.

FIG. 3c shows a cross-sectional view of an exemplary embodiment of a housing member with straight sides. Also visible is external threading 24a.

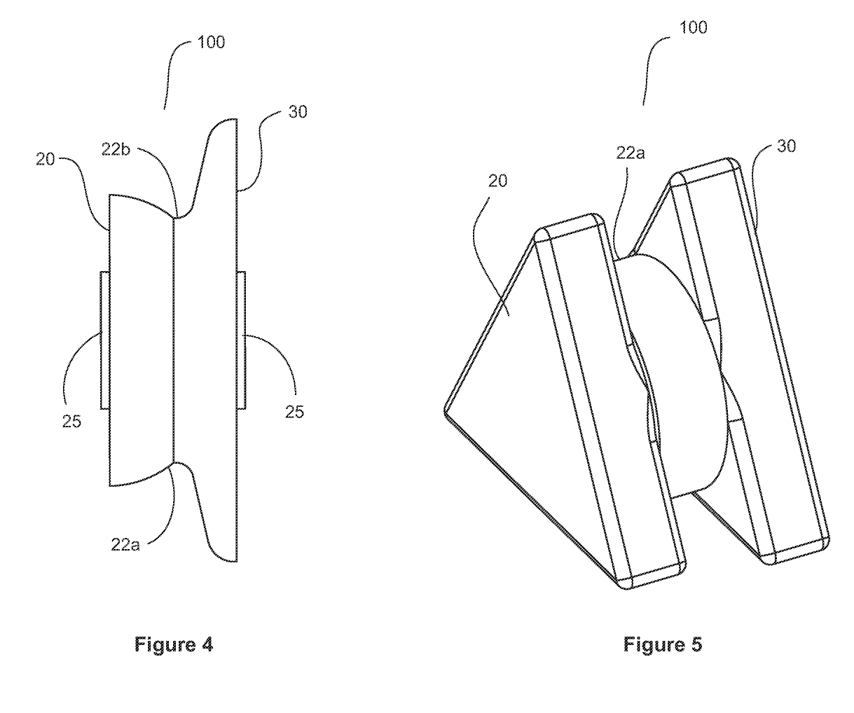

FIG. 4 shows a side perspective view of an third exemplary embodiment of reusable high-temperature resistant masking device 100 in which first housing member 20 has rounded sides and second housing member 30 has longer, flatter sides than second housing member 30 illustrated in FIG. 1b. In the embodiment shown, second housing member 30 has a substantially larger diameter than first housing member 20. In other embodiments, there is a less or greater difference between the diameters of first housing member 20 and second housing member 30.

FIG. 5 shows a side perspective view of an fourth exemplary embodiment of reusable high-temperature resistant masking device 100 in which first housing member 20 and second housing member 30 have a triangular shape. In other embodiments, first housing member 20 and second housing member 30 are of a different shapes (e.g., rectangular, oval, round, disc-shaped).

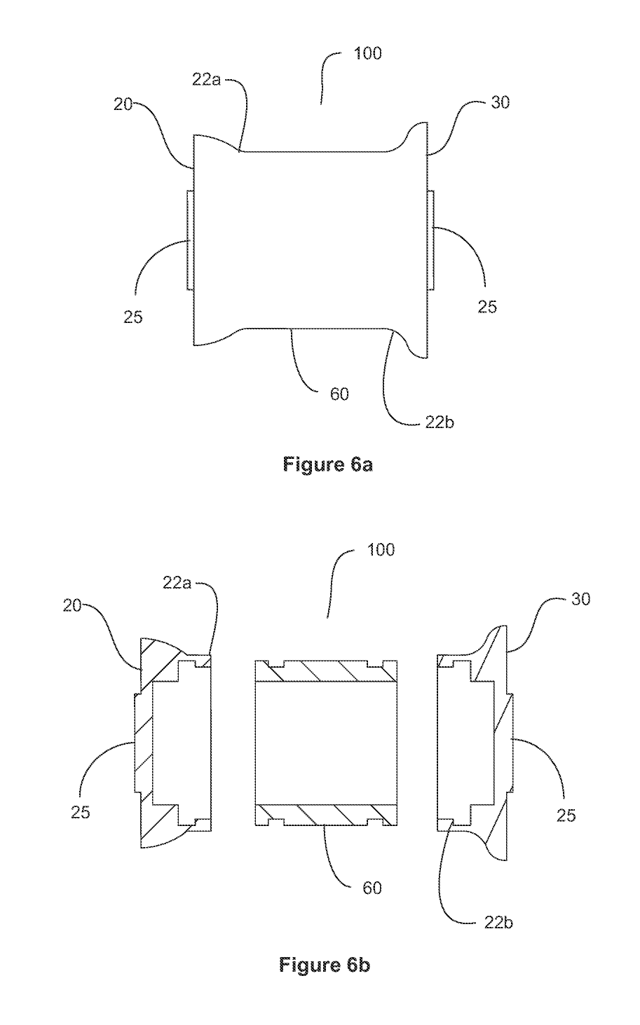

FIG. 6a shows a side perspective view of a fifth exemplary embodiment of reusable high-temperature resistant masking device 100 in the assembled position. FIG. 6b shows a cross-sectional view of an exemplary embodiment of reusable high-temperature resistant masking device 100 in the unassembled position. Reusable high-temperature resistant masking device 100 include neck extension member 60. Neck extension member 60 may be attached to either first housing member 20 and/or second housing member 30 as a singly molded component (FIG. 6a), or may be provided as a separate component adapted for selective attachment and detachment to first housing member 20 and second housing member 30 (FIG. 6b).

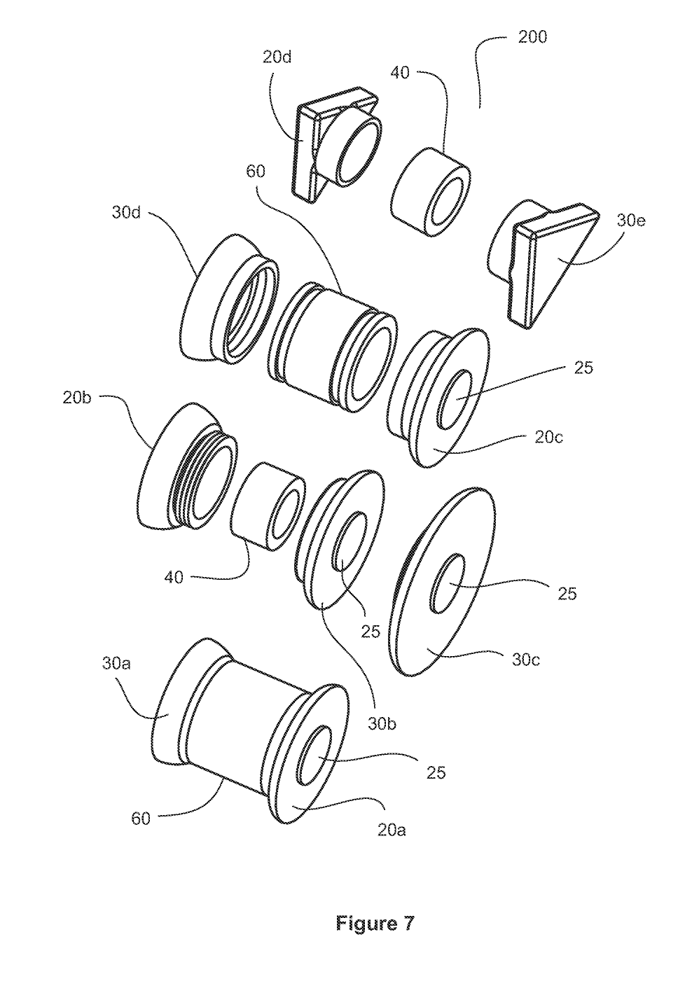

As illustrated in FIG. 7, reusable high-temperature resistant masking devices may be provided to a user in the form of kit 200. In the embodiment shown, kit 200 contains a variety of interchangeable first housing members 20a, 20b, 20c, 20d and second housing members 30a, 30b, 30c, 30d, 30e of different sizes and shapes along with one or more magnets 40 and one or more neck extensions 60. In other embodiments, kit 200 contains more or fewer interchangeable components.

To use, a user selects a first housing member 20a, 20b, 20c or 20d of a desired size and shape and a second housing member 30a, 30b, 30c, 30d or 30e of a desired size and shape. Magnet 40 is placed within the selected housing members which are then joined together to form a masking device which encloses and insulates magnet 40 on all four sides during the coating and curing process.

It is to be understood that coloring, labeling, or numbering indicia may be incorporated to assist a user in selecting a part of optimal shape and size.

The kit arrangement provides the ability to make both custom parts (e.g., first housing member 20 and second housing member 30) for the needs of a specific user by creating custom molds, and the ability to replace the magnet 40 to prolong the life of use of the custom parts.

The kit arrangement also provides the ability to use one magnet 40 within first housing member 20 and second housing member 30 of varying sizes and shapes to reduce the cost of the magnet 40 (i.e., separate magnets 40 need not be purchased for each set of housing members 20 and 30).

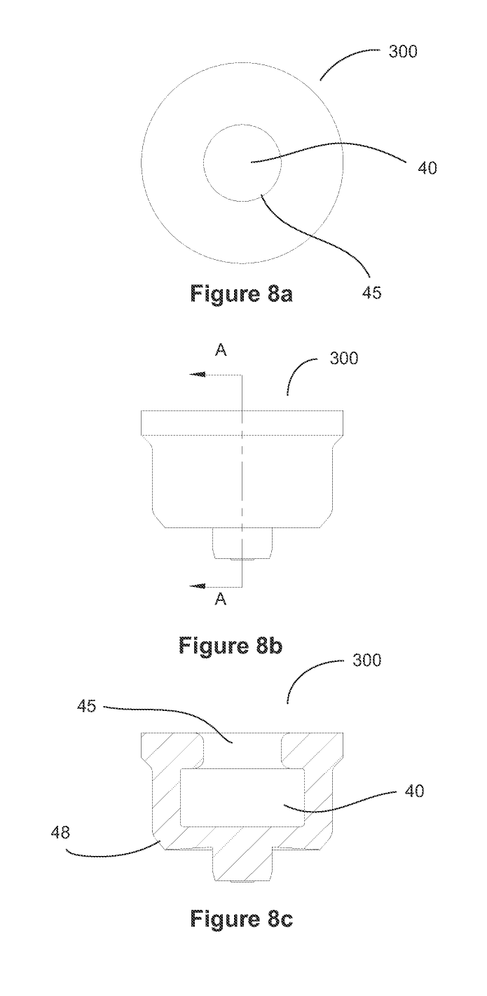

FIG. 8a shows a top perspective view of an exemplary embodiment of reusable high-temperature resistant masking device 300 manufactured as a unitary component. In the embodiment shown, reusable high-temperature resistant masking device 300 is manufactured from a deformable material, e.g., silicone, EPDM rubber, elastomers or combinations thereof. The deformable characteristic of reusable high-temperature resistant masking device 300 allows magnet 40 to be wedged into opening 45. The material then snaps around magnet 40 locking it into place in the interior of reusable high-temperature resistant masking device 300. A portion of the top surface of magnet 40 remains exposed.

In the embodiment shown, reusable high-temperature resistant masking device 300 has overhang 48 (not visible) which helps to deflect paint and minimize paint burr. In the embodiment shown, overhang 48 is angled. Using an angled design makes reusable high-temperature resistant masking device 300 stiffer than a square-cornered design resulting is a slower rate of deterioration. In other embodiments, overhang 48 may be a contour, protrusion, protuberance, ridge, channel, groove, curve, chamfer, rounded edge or any other structural feature adapted to minimize paint burr.

In other embodiments, the interior of reusable high-temperature resistant masking device 300 contains threads which help to locate magnet 40. In all embodiments of reusable high-temperature resistant device 300, the device may also be disposable. In all embodiments of reusable high-temperature resistant masking device 300, the device may further have a layer of paint resistant coating or a release agent on the outer surface to deflect paint or coating.

When a deformable material that allows a magnet to be wedged into the interior of reusable high-temperature resistant masking device 300 is used, a second component (e.g., second housing member) to contain magnet 40 is not necessary, cutting down on the cost of manufacturing reusable high-temperature resistant masking device 300. Deformable material, however, is generally not as heat-resistant as Teflon and paint sticks to deformable material more than it sticks to Teflon. On the other hand, deformable material, in addition to not requiring a second component to act as a cover, is more durable and less susceptible than Teflon to dents and scratches that can result from use, handling and storage. Deformable material also typically provides a better sealing surface, particularly when coating using a liquid bath (e.g., e-coating).

The lack of a component which covers opening 45 allows paint to build-up on magnet 40. The nature of the deformable material, however, allows magnet 40 to be removed easily. Once removed, the paint can be broken off magnet 40. In addition, magnet 40 can be removed and placed into another reusable high-temperature resistant masking device 300.

FIG. 8b shows a side perspective view of an exemplary embodiment of reusable high-temperature resistant masking device 300 manufactured as a unitary component.

FIG. 8c shows a cross-sectional view of an exemplary embodiment of reusable high-temperature resistant masking device 300 manufactured as a unitary component taken along line A. Magnet 40 is visible in the interior of reusable high-temperature resistant masking device 300.

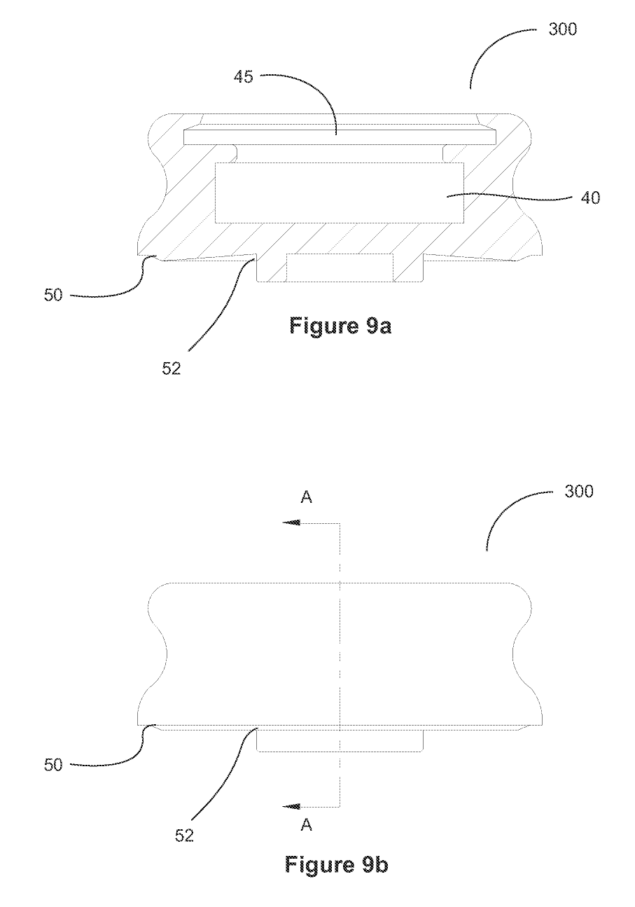

FIG. 9a shows a cross-sectional view of a second exemplary embodiment of reusable high-temperature resistant masking device 300 manufactured as a unitary component. In the embodiment shown, reusable high-temperature resistant masking device 300 is manufactured from a deformable material, e.g., silicone or EPDM rubber and includes deflecting lip 50. Deflecting lip 50 deflects paint and minimizes paint burr by causing the paint or powder to drift underneath it instead of building up at sealing surface 52.

In the embodiment shown, deflecting lip 50 is angled. In other embodiments, deflecting lip 50 may be straight with square corners, of varying radiuses, a contour, protrusion, protuberance, ridge, channel, groove, curve, chamfer, or be of any other shape or configuration adapted to minimize paint burr. The dimensions, thickness, shape and configuration may vary depending on the type of process and type of paint used. For example, the height of deflecting lip 50 may range from zero (i.e., flat) to 200 thousands of an inch. The depth of deflecting lip 50 may range from 10 to 200 thousands of an inch. Deflecting lip 50 may be either Teflon, silicone, EMPD rubber or any other material.

In the embodiment shown, the sides of reusable high-temperature resistant masking device 300 are curved and concave. In other embodiments, reusable high-temperature masking device may have straight sides, curved sides, rounded sides or tapered sides with varying degrees of angling.

FIG. 9b shows a side perspective view of a second exemplary embodiment of reusable high-temperature resistant masking device 300 manufactured as a unitary component.

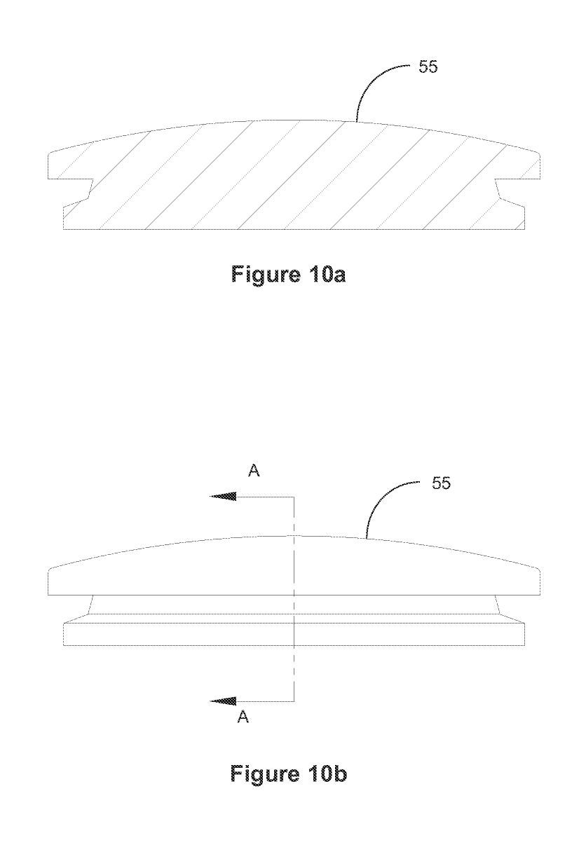

FIG. 10a shows a cross-sectional view of optional lid 55 for reusable high-temperature resistant masking device 300. In the embodiment shown, the configuration of lid 55 corresponds to the configuration to opening 45 of reusable high-temperature resistant masking device 300 shown in FIGS. 9a and 9b. Lid 55 snaps into reusable-temperature resistant masking device 300 and closes off magnet 40 protecting it from paint build-up during the coating process. In the embodiment shown, lid 55 is made of silicone. In other embodiments, lid 55 is manufactured from a different material such as EPDM rubber and may have a Teflon or release agent coating.

FIG. 10b shows a side perspective view of optional lid 55 for reusable high-temperature resistant masking device 300 manufactured as a unitary component.

What is claimed is:

1. A reusable high-temperature resistant masking device comprised of:
a housing constructed of a material capable of withstanding temperatures of 600 degrees Fahrenheit and further including at least one aperture for insertion of at least one magnetic component;
at least one magnetic component adapted to fit within said housing; and
at least one centering protrusion.

2. The reusable high-temperature resistant masking device of claim 1 wherein said at least one magnetic component is enclosed on all sides by said housing.

3. The reusable high-temperature resistant masking device of claim 1 wherein said housing is comprised of a first housing member and a second housing member.

4. The reusable high-temperature resistant masking device of claim 3 wherein said first housing member and said second housing member are threaded.

5. The reusable high-temperature resistant masking device of claim 3 wherein said first housing member and said second housing member are adapted to be interlocking.

6. The reusable high-temperature resistant masking device of claim 1 wherein said at least one magnetic component is enclosed by a unitary housing component.

7. The reusable high-temperature masking device of claim 1 wherein said housing is constructed from a temperature resistant material selected from a group consisting of Teflon, silicone, EPDM rubber, nylon, synthetic polymers and elastomers.

8. The reusable high-temperature resistant masking device of claim 6 wherein said unitary housing component is constructed from a deformable material.

9. The reusable high-temperature resistant masking device of claim 6 which further includes at least one opening for insertion of said at least one magnetic component.

10. The reusable high-temperature resistant masking device of claim 9 which further includes at least one plug for sealing said at least one opening for insertion of said at least one magnetic component.

11. The reusable high-temperature resistant masking device of claim 8 wherein said deformable material is selected from a group consisting of silicone, EPDM rubber, nylon, synthetic polymers and elastomers.

12. The reusable high-temperature resistant masking device of claim 1 wherein said housing further includes a deflecting lip.

13. The reusable high-temperature resistant masking device of claim 1 wherein said housing further includes a structural component which minimizes paint burr.

14. The reusable high-temperature resistant masking device of claim 1 wherein said housing further includes a chamfer.

15. The reusable high-temperature resistant masking device of claim 1 wherein said housing further includes a paint resistant coating.

16. The reusable high-temperature resistant masking device of claim 1 wherein said housing is comprised of a Teflon equivalent.

17. The reusable high-temperature resistant masking device of claim 12 wherein said deflecting lip has of height between 0 and 200 thousandths of an inch.

18. The reusable high-temperature resistant masking device of claim 12 wherein said deflecting lip has a depth of between 10 and 200 thousandths of an inch.

19. A method of manufacturing a reusable high-temperature resistant masking device comprised of:
manufacturing a housing having at least one aperture and at least one centering protrusion from a material capable of withstanding temperatures of 600 degrees Fahrenheit; and
inserting at least one magnetic component within said at least one aperture.

20. The method of manufacturing a reusable high-temperature resistant masking device of claim 19 wherein said material capable of withstanding temperatures of 600 degrees Fahrenheit is selected from the group consisting of Teflon, Teflon equivalent, silicone, EPDM rubber, nylon, synthetic polymers and elastomers.

21. The method of manufacturing a reusable high-temperature resistant masking device of claim 19 wherein said housing further includes a deflecting lip having a height between 0 and 200 thousandths of an inch and a depth between 10 and 200 thousandths of an inch.

22. A system of power-coating a surface comprised of:
a reusable high-temperature resistant masking device comprised of:
a housing constructed of a material capable of withstanding temperatures of 600 degrees Fahrenheit and further including at least one aperture for insertion of at least one magnetic component; and
at least one magnet component adapted to fit within said housing;
at least one centering protrusion; and
a powder coating compound.
